(19) United States
(12) Patent Application Publication
(10) Pub. No.: US 2026/0308475 A1
(43) Pub. Date: Oct. 8, 2026

(54) A PROCESS AND APPARATUS FOR REFINING A VEGETABLE OIL

(71) Applicant: INTREFT PTY LTD, Hamilton Hill (AU)

(72) Inventors: Sundar PANDIAN, Hamilton Hill (AU); Ashley PALMER, Hamilton Hill (AU)

(73) Assignee: INTREFT PTY LTD, Western Australia (AU)

(21) Appl. No.: 19/483,159

(22) PCT Filed: May 8, 2024
(86) PCT No.: PCT/AU2024/050447

§ 371 Date: Nov. 10, 2025

(30) Foreign Application Priority Data
May 11, 2023 (AU) 2023901432

(51) Int. Cl. C11B 3/14; C11B 3/00

(52) U.S. Cl. CPC C11B 3/14; C11B 3/006; C11B 3/008

(57) ABSTRACT

A process for physically refining a vegetable oil comprising a step of deodourising a crude vegetable oil by steam distillation under refining conditions effective to produce a refined vegetable oil having a trans-fat content of less than 0.99 wt %. The steam is generated from water substantially free of chlorine to prevent formation of organic chlorine, particularly in the form of 2-MCPD and 3-MCPD.

### TECHNICAL FIELD

The present invention relates to a process and apparatus for refining a vegetable oil.

### BACKGROUND ART

The following discussion of the background art is intended to facilitate an understanding of the present invention only. The discussion is not an acknowledgement or admission that any of the material referred to is or was part of the common general knowledge as at the priority date of the application.

The refining of plant oils is complex, either following a physical or chemical refining route with a number of unit operations directed at removal of impurities. Typically, in an initial step, the oil-bearing seed/fruit is pressed or crushed, typically with heating including a so-called expeller process, to maximise oil recovery. The oil is then extracted into petroleum solvent, typically hexane. The petroleum solvent is removed to recover a crude oil which includes a range of impurities including phospholipids, other fatty acids, organic sulphur compounds, waxes, dye compounds and the like. These impurities have adverse effects on the taste, odour and quality of an edible oil-though may have value as a by-product-so removing them to make the oil marketable and useful is a necessity. Such a crude oil may also include chlorine for example as introduced as agricultural chemicals during growth of oil bearing plants.

Removal of the impurities has made it necessary to use many further processing steps including: degumming, refining, bleaching and deodourising in a chemical refining scheme which uses a range of chemicals and may be expensive. For example, free fatty acids are typically reduced in content through use of an alkaline or caustic refining step in which free fatty acids are converted to soaps that can be removed, with some difficulty, from the oil.

U.S. Pat. No. 6,172,248, the contents of which are hereby incorporated by reference, discloses a chemical refining process, involving admixing of a heated stream of vegetable oil with a dilute aqueous Inorganic or organic acid solution (selected from the group consisting of phosphoric acid, acetic acid, citric acid, tartaric acid, succinic acid and mixtures thereof) following discussion of the disadvantages of alkaline refining such as losses of oil due to emulsification with soapstock, difficulties in soapstock handling and difficulty in disposal of acidic water created in soapstock splitting.

Chemical refining also leaves traces of treatment chemicals in the refined oil product which may be undesirable in some applications such as ‘numbers free’ applications.

An alternative to chemical refining is physical refining which, though generally applicable to vegetable oils, has mostly been confined to palm oil production. As disclosed in U.S. patent application No. 2014018561, directed to the refining of palm oils, physical refining is an abridged chemical refining route so still involves the use of chemicals and heating during crushing or pressing. Such physical refining is typically a three-stage continuous operation in which incoming crude oil (water degummed crude oil) is treated with acid, in a gum conditioning step and cleansed in a bleaching step with an adsorbent. The oil is then subjected to steam distillation. This process allows for the subsequent deacidification, deodourisation, and removal of carotenoids unique to palm oil. These carotenoids give palm oil its characteristic red colour. Given the lack of a neutralisation step in physical refining, refined bleached oil (RBO) from a physical refinery has nearly the same free fatty acid (FFA) content as found in the crude oil. U.S. 2014018561 seeks to address this issue by bleaching involving heating the oil and cleaning the oil by passing it through adsorptive bleaching clay. Steam distillation for deodourisation follows.

Regrettably, refined vegetable oils may contain contaminants or impurities-some generated by the refining process as well as during oil bearing plant growth-which are now becoming recognised as a source of adverse health effects, for example as carcinogens. Such chemicals include organic chlorine including in the form of chlorinated propanediols, such as 3-monochloropropanediol (3-MCPD) and 2-monochloropropanediol and glycidyl esters (GEs). Organic chlorine contamination is an emerging issue in refining of vegetable oils.

As far as removal of organic chlorine is concerned, recently developed processes for removal include physical and/or chemical processing of oil following a deodourisation step. For example Australian Patent No. 2018273218 (Cargill Inc) discloses use of short path evaporation following processing. This process may require additional de-odourisation to restore preferred taste characteristics.

International Publication No. WO2022144769 (Technology) discloses a three stage process involving heat treatment with carbonates and/or bicarbonates of alkaline and alkaline earth metals; citric acid washing; and refining of the oily and aqueous phases by vacuum flash and decantation respectively. Such processes have either or both of the issues of traces of treatment chemicals being left in the refined product oil or damage to the quality of the refined product oil due to multiple processing steps.

Further, the processing of vegetable oils may cause inclusion of mineral oil hydrocarbons (MOH). MOH comprises two main groups referred to as MOSH (mineral oil saturated hydrocarbons) and MOAH (mineral oil aromatic hydrocarbons). MOSH and MOAH are found in vegetable oils as well as food products containing such vegetable oils. MOAH may be a carcinogen and MOSH accumulates in the liver and lymphatic systems. Infant formula MOAH concentrations in the range of 0.9-3.5 mg/kg have caused health concerns and Europe has implemented regulations for controlling the levels of these compounds in vegetable oils and other food products, in particular infant formula.

The present invention has been developed against the above background.

### SUMMARY OF INVENTION

In one aspect, the present invention provides a process for physically refining a vegetable oil comprising a step of deodourising a crude vegetable oil by steam refining under refining conditions effective to produce a refined vegetable oil having a trans-fat content of less than 0.99 wt %, said steam being generated from water substantially free of chlorine.

In another aspect, the present invention provides an apparatus for physically refining a vegetable oil comprising a deodourising vessel for steam refining a crude vegetable oil with steam under refining conditions effective to produce a refined vegetable oil having a trans-fat content of less than 0.99 wt %, said steam being generated from water substantially free of chlorine.

The process and apparatus of embodiments of the invention involve physical refining. Omitted is a chemical refining step, which would typically involve contacting of oil with chemicals—such as aqueous alkali solution—for the removal of non-hydratable phosphatides, soaps created from the neutralisation of free fatty acids and other impurities such as metals. This avoids a soapstock handling problem and reduced losses of oil through saponification.

Steam refining, which conveniently involves steam distillation with pressurised stripping steam under vacuum, is preferably conducted under a plurality of controlled conditions selected from the group consisting of vacuum pressure, temperature, stripping steam rate, stripping stream pressure, fatty acid vapour pressure, crude oil flowrate through steam refining and combinations thereof. The steam refining process is conducted in a manner to minimise generation of trans fats above a level naturally existing in a crude vegetable oil. The steam refining process or steam distillation is also conducted at a steam stripping rate to minimise hydrolysis of the vegetable oil and the undesirable formation of glycidyl esters (GEs) which may be metabolised by the human body as carcinogenic glycidol.

Desirably, steam is generated from water or condensate treated to minimise or remove chlorine, conveniently by a membrane treatment such as reverse osmosis to remove chlorine introduced by chlorination processes or chlorides. In such case, steam refining is with steam having substantially zero chlorine content. The absence of chlorine makes formation of organic chlorine compounds, such as chloropropanol in the form of 2-MCPD or 3-MCPD, less likely.

The steam distillation is conducted, to remove fatty acids amongst other impurities. Steam distillation is conducted at a relatively low and advantageously narrow temperature range at temperature less than 230° C., preferably in the range 220-230° C. and most preferably above 225-230° C., the achievable temperature being correlated with the above described operating parameters, in particular vacuum pressure, steam stripping rate, stripping steam pressure and crude oil flowrate through steam distillation, selected values for each of the parameters also depending on economic constraints relating, amongst other factors, to the construction of the deodourising vessel.

The greater the vacuum (or lower absolute pressure), the greater the volume of stripping steam and stripping steam rate that can be achieved because of relative steam expansion according to the ideal gas law. Thus, the greater the vacuum, the lesser the quantity of steam required to achieve the same amount of stripping and this is conducive to lower formation of glycidyl esters (GEs), also known as glycidyl fatty acid esters, because there is a lesser extent of hydrolysis of the fatty acids present in the oil. Bearing such considerations in mind, steam distillation is advantageously conducted at a vacuum less than 1.5 torr, preferably less than 1.0 torr and more preferably less than 0.6 torr though above 0.4 torr, optionally in the range 0.5 to 1.0 torr, optionally in the range 0.5 to 0.8 torr.

Stripping stream pressure is preferably controlled in the range of 0.8 bar gauge to 2.0 bar gauge, preferably 1 bar gauge to 1.5 bar gauge, and stripping steam rate is also desirably controlled to achieve target fatty acid contents in the refined vegetable oil and, as mentioned above, to minimise vegetable oil hydrolysis. Residence time in the distillation vessel is preferably within the range 30 minutes to 120 minutes. All other factors being equal, and with temperature desirably within the above ranges, trans fat content formation is reduced with increased oil flowrate.

Under such steam distillation conditions, both organic chlorine content and GE content in the refined oil (even though formed by different mechanisms) may be reduced to very low levels, below 1.0 ppm, 0.5 ppm or 0.25 ppm and desirably undetectable levels. While prescribed regulatory limits are product dependent and therefore complex, such very low levels are below those limits. GE content in refined oil may also be reduced to less than such regulatory limits. In both cases, free fatty acid contents and trans-fat content may also be maintained at a low level. Products made using the refined oil also have organic chlorine content and GE content at such very low levels and regulatory limits, for example for infant formula.

Still further, the process allows production of a refined oil having a very low content of MOSH and MOAH compounds where these have been introduced to an oil such as from trace lubricating oils from seed processing equipment. Oils refined according to the above process may contain less than 10 ppm, less than 5 ppm or undetectable levels of MOSH and MOAH. Such refined oils therefore conform with regulations such as Commission Regulation (EU) 2023/915 of 25 Apr. 2023. In addition, infant formulae, follow-on formulae and food for special medical purposes intended for infants and young children as well young-child formulae prepared using the refined oils would—to the extent that the contaminant is formed during oil refining—comply with Commission Regulation 2023/915 and like regulations in the future. Oils refined by the above-described process may also be used for pharmaceutical applications.

In addition, free fatty acid (FFA) contents in the refined oil may be reduced to less than 0.1 wt %, preferably less than 0.08 wt %, more preferably less than 0.07 wt % and most preferably less than 0.06 wt %. Trans fat formation and so its content in the oil is limited to less than 0.99 wt %, preferably less than 0.8 wt %, more preferably less than 0.7 wt % and most preferably less than 0.6 wt %.

Steam distillation is preferably conducted in a distillation vessel or tower having a plurality of vertically spaced trays, conveniently overflow trays, with conditions at each tray being controlled to achieve said effective conditions. However, the distillation vessel could also be a packed tower or a tower including a portion with trays and a portion with packing. Other forms of distillation vessel are not precluded.

Upstream of the distillation tower may be included further free fatty acid volatilisation process vessels, selected from the group consisting of flashing and pre-distillation vessels. Inclusion of such further process vessel(s) allow treatment of higher free fatty acid content crude oils and reduces vapour load in the steam distillation vessel. At the same time, inclusion of such further volatilisation steps may increase oil throughput.

The refining process as described herein desirably includes additional steps to deodourisation, notably crude oil extraction, bleaching (with a bleaching agent having low to no chlorine content) and degumming. Typically, and in contrast, chemical vegetable oil refining involves the unit operations of degumming, refining, bleaching and deodourising. Free fatty acids are primarily removed in the deodourising step which is conducted under temperature, pressure and feed rate conditions effective to limit further formation of trans fats and glycidyl esters.

Oil is preferably extracted while avoiding heating and cooking of the oil which can reduce its quality, for example in terms of trans fat formation. Cold or natural pressing can be used for extraction, using the same expeller process but is conducted in the absence of a solvent and without heating and cooking. A petroleum solvent, such as hexane, should not be used to extract the oil.

Degumming may involve a water degumming process, as understood in the art of vegetable oil refining, which involves admixture of water and a low concentration of an organic acid, such as citric acid, with the crude vegetable oil and separating the resulting mixture into an oil component and an oil-insoluble wet gum component, for example using centrifugal separation. Naturally produced organic acid, rather than chemically produced phosphoric acid, is most preferred for degumming.

Following degumming, the refining process desirably includes a bleaching step with an adsorbent prior to deodourising. Conventional adsorbents used in vegetable oil refining, such as aluminosilicates, may be used in the bleaching step provided that these have low to no chlorine content.

A further embodiment of the present invention provides a process for physically refining a vegetable oil comprising the steps of:
(a) extracting a crude vegetable oil;
(b) degumming and bleaching the crude vegetable oil for initial removal of impurities; and
(c) deodourising a crude vegetable oil by steam refining under conditions effective to produce a refined vegetable oil having a trans fat content of less than 0.99 wt %; and
   further comprising a chlorine reduction step.

As apparent from the above, steam used in the steam refining is—in the most preferred embodiments of the invention—is generated from water substantially free of chlorine. Thus, water used to generate steam may be treated by a membrane treatment process, such as reverse osmosis, to reduce or even substantially eliminate chlorine present as free chlorine, organic chlorine or inorganic chlorine. The membrane treatment step is the chlorine reduction step.

Chlorine reduction may also be achieved by a step selected from the group of washing and controlling the quantity of chlorine introduced to a refining step, for example by reducing steam flow where steam contains chlorine. Washing may, for example, be conducted of crude or unrefined oil or of seeds or fruit directed to the process or the apparatus described below.

The above chlorine reduction step is desirably conducted upstream of the deodourisation step. Preferably, a plurality of chlorine reduction steps are included.

A still further embodiment of the present invention provides an apparatus for physically refining a vegetable oil comprising:
(a) a presser, desirably operated at ambient conditions, for extracting a crude vegetable oil;
(b) a series of vessels for degumming and bleaching the crude oil for initial removal of impurities;
(c) a vessel for deodourising a crude vegetable oil by steam refining under conditions effective to produce a refined vegetable oil having a trans-fat content of less than 0.99 wt %; and
(d) a chlorine removal stage.

It will be understood that a chlorine removal stage could also be described as a chlorine reduction stage, chlorine reduction being described above. Thus, in embodiments, the chlorine removal stage could include a washing stage or a water treatment stage, the water treatment stage being used to reduce or even substantially eliminate the presence of chlorine in water used for the generation of steam. Desirably, therefore, the chlorine removal stage is located upstream of deodourisation. Preferably, a plurality of chlorine removal stages are included.

Vegetable oils which may be refined according to the process include those oils which are more vulnerable to trans fat formation, as indicated for example by their omega-3 fatty acid content in the crude state. Such vegetable oils include—without limitation—canola or rapeseed oil, soybean oil, flaxseed oil, walnut oil, or combinations thereof. Oils with lower omega-3 fatty acid content, and therefore less susceptible to trans fatty acid formation—such as palm oil, cottonseed oil and sunflower oil—may also be treated with the refining process described in this specification.

Another aspect of the invention provides a refined vegetable oil produced by the above described process and having a trans-fat content less than 0.99 wt % and organic chlorine and GE levels at very low or undetectable levels as above described.

The term “organic chlorine” as used herein includes, in particular, 2-MCPD and 3-MCPD (monochloropropanediols) as well as 1,3-DCP and 2,3-DCP (dichloropropanols) and their esters.

Such a refined vegetable oil should not require additives selected from the group of antioxidants and anti-foam agents.

Further, a vegetable oil refined as described above maintains tocopherol content with tocopherol losses being reduced at the lower refining temperatures without a trade off with trans-fat content. By way of example, the process may allow retention of 50-60% of the tocopherols in the crude vegetable oil whereas typical physical refining processes would be expected to retain only 20-30% of tocopherol present in the crude vegetable oil.

An oil produced by the above-described process has a low content of FFAs but also a low content of trans fats. Further, the refining process—with steam being substantially free of chlorine—reduces or avoids formation of 2-MCPD and 3-MCPD. MOAH and MOSH are also present at very low or undetectable levels. At the same time, through the minimisation or avoidance of use of chemicals during the refining process, the oil has a specification which allows it to be sold at a premium as “chemical free” or “numbers free”.

### BRIEF DESCRIPTION OF THE DRAWINGS

Further features of the present invention are more fully described in the following description of several non-limiting embodiments thereof. This description is included solely for the purposes of exemplifying the present invention. It should not be understood as a restriction on the broad summary, disclosure or description of the invention as set out above. The description will be made with reference to the accompanying drawings in which:

FIG. 1 is a block diagram schematically showing a chemical process for refining plant oils according to the prior art.

FIG. 2 is a block diagram schematically showing a physical refining process for refining plant oils according to the prior art.

FIG. 3 is a block diagram schematically showing a process for refining vegetable oils according to one embodiment of the present invention.

FIG. 4 is a detail of an arrangement of process vessels in the deodourisation step according to one embodiment of the present invention.

FIG. 5 is a detail of an arrangement of process vessels in the deodourisation step according to another embodiment of the present invention.

### DESCRIPTION OF PREFERRED EMBODIMENTS

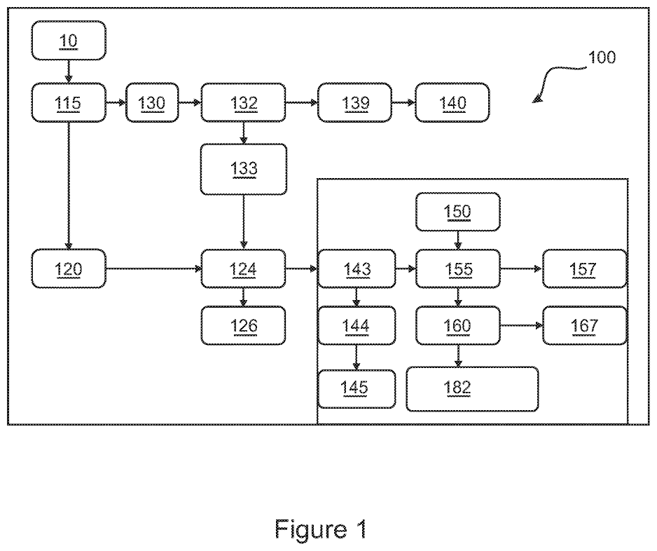

Referring now to FIG. 1, a prior art scheme 100 for chemically refining a vegetable oil, such as canola oil, proceeds as follows. Canola oil seeds 10 are crushed in a hot or expeller crushing step 115 at above ambient conditions, for example about 110° C., to produce a crude canola oil 120 and an oil cake 130. Oil cake 130 is contacted with hexane to extract residual oil 133 in extraction step 132. These steps have the benefit of optimised extraction of oil but with the loss of quality due to heating and the addition of hexane which must be removed to produce a deoiled cake or ‘meal’ 139 which can be directed as a feedstock 140, typically for animal consumption.

Crude canola oil 120 contains impurities that must be removed following a somewhat complex series of chemical steps. In step 124, crude canola oil 120 is contacted with water and acid to remove gums. A gum fraction 126 can be separated from an oil fraction which is directed to caustic refining step 143 which involves contacting of oil with a hot solution of caustic soda to form, through saponification, sodium soaps (soapstock) 144 on reaction with fatty acids present in the oil. The saponification process causes an oil loss which, for economic reasons, requires treatment of the soapstock 144 to produce a by-product acid oil 145 by acidulation.

By this stage, the oil fraction has been depleted of a significant proportion of its fatty acid content. The oil fraction is contacted with a bleaching agent 150 in bleaching step 155 to remove colour and other impurities. Typical bleaching agents include aluminosilicates such as neutral earths, acid-activated earths, activated carbon, silicates and mixtures thereof. In bleaching step 155, oil is mixed with an amount of a bleaching agent, heated under vacuum to a bleaching temperature, filtered and directed to deodourisation step 160. Bleaching agent following adsorption, or spent earth 157, is disposed of or possibly regenerated for further use.

Deodourisation step 160 involves contacting of oil with steam generated from process water (containing an amount of chlorine) in a steam distillation process to remove volatile impurities that reduce quality through odour or poor taste. The deodourisation step 160, conducted under vacuum in a distillation vessel having a number of vertically spaced trays, is intended to deplete the oil of remaining free fatty acids to produce a product oil 182. Distilled fatty acids 167 may have value as a by-product.

As described in U.S. Pat. No. 6,172,248, steam temperature and the time for which the steam contacts the vegetable oil are both important variables directly influencing the types and amounts of volatile impurities that can be removed by steam distillation. Higher temperatures facilitate removal of volatile impurities but also favour reactions that convert less harmful cis fatty acids to trans fatty acids. Lower temperatures reduce the formation of trans fatty acids but at the cost of reducing deodourisation step 160 throughput by requiring longer contact times. This may also indicate a larger and more expensive distillation vessel. Deodourisers, as described in U.S. Pat. No. 6,172,248, may operate at a temperature of 230 to 265° C. and a pressure of about 6 torr, requiring a 45 to 60 minute residence time in the distillation vessel.

Steam requirements for vacuum steam deodourisation step 160 are generally inversely proportional to the vapour pressure of the volatile impurities of the oil at the operating temperature. Thus, for economical operation, deodourisation step 160 is carried out at as high a vacuum as practically possible. Steam vapourises the volatile impurities and carries them away from the oil. U.S. Pat. No. 6,172,248 discloses that, generally, steam in an amount of about 0.5 to about 3.0 percent by weight of oil is required at an operating pressure of about 3 torr. At a higher operating pressure of about 6 torr, steam in an amount of about 2 to about 5 percent by weight of oil is generally required.

The product oil 182 is chemically refined, and though commercially acceptable, depleted of quality due to the heat crushing step 115 and caustic refining step 143. In addition, the product oil 182 contains traces of the chemicals used during its refining and has a trans fatty acid content of about 0.7 wt % in the refined oil. In addition, anti-oxidants and anti-frothing agents must be added to the product oil 182 prior to sale. Product oil 182 would not be suitable for a ‘numbers free’ application and a higher premium achievable for ‘numbers free’ oils.

Refined oils produced using the scheme 100 may either, for example, contain organic chlorine due to the presence of chlorine in the water used for generation of steam. Further, the steam stripping rates are such as to cause hydrolysis and formation of glycidyl esters above 1000 ppm or higher. Alternatively, dual bleaching and dual deodourisation steps or further chemical treatments must be performed to reduce organic chlorine and glycidyl esters below the 1000 ppm level, for example using prior art processes as described above.

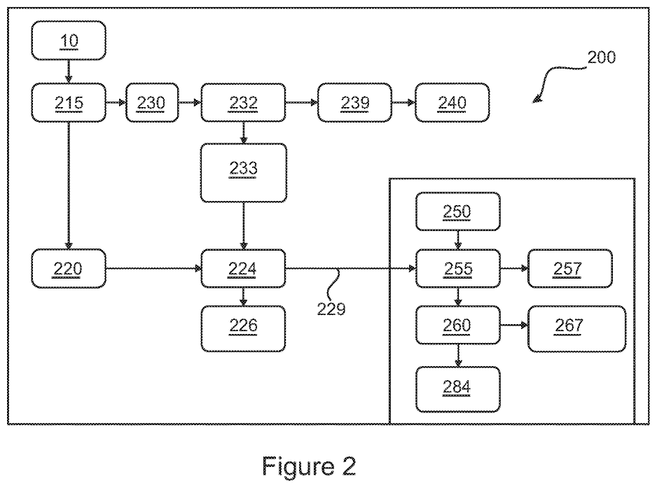

Referring to FIG. 2, a prior art scheme 200 for physically refining a vegetable oil, typically palm oil, proceeds as follows. Steps in common with those in scheme 100 are numbered the same or with the prefix “2” rather than “1”. Prior art scheme 200 follows essentially the same steps as for scheme 100 but the caustic refining step 143 and treatment of the soapstock 144 to produce a by-product acid oil 146 are absent. Deodourisation conditions are essentially the same as described above noting that steam is generated from process water containing an amount of chlorine. Physical refining processes have generally been confined to palm oil processing.

Again, as with scheme 100, physically refined oils produced using the scheme 200 may either, for example, contain organic chlorine and glycidyl esters above 1000 ppm or higher. Alternatively, dual bleaching and dual deodourisation steps or chemical treatments must be performed to reduce organic chlorine and glycidyl esters below the 1000 ppm level, for example using prior art processes such as short path distillation or chemical treatment as described above with their concomitant disadvantages. One such disadvantage is that the refined oil cannot be used in a ‘numbers free’ application.

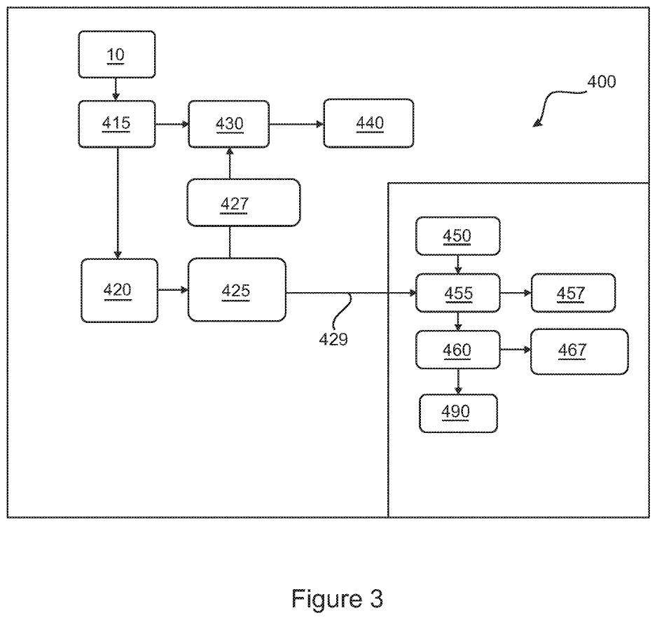

Referring to FIG. 3, a scheme 400 for the physical refining process of a vegetable oil—according to one embodiment of the present invention—proceeds as follows. Steps in common with those in schemes 100 and 200 are numbered the same or with the prefix “4” rather than “1” or “2”.

Canola oil seeds 10—preferably with an organic chlorine content as low as available from a plantation—are crushed in crushing step 415 to extract the oil in a cold pressing or natural crush process which does not involve heating of the oil. Rather, pressing is conducted at ambient conditions or even with refrigeration. Oil cake 430 is not contacted with hexane to minimise oil losses prior to directing it as a feedstock 440. This means accepting a certain oil loss but the improved quality of product oil 490 including its very low trans fatty acid content provides value that compensates for oil losses at the front end of scheme 400.

In desirable embodiments, the extracted unrefined or crude canola oil 420 is washed with chlorine free water to remove chlorine containing compounds from the unrefined oil in optional washing stage 422, a first chlorine removal or reduction stage.

Washed crude canola oil 424, which contains about 0.2 wt % trans fats, is degummed through a conventional water degumming process 425, as understood in the art of vegetable oil refining, which involves admixture of water and natural organic acid, preferably natural citric acid in low concentration (e.g. between 10 and 30 wt % citric acid solution) as understood by those skilled in the art of vegetable oil refining, with the crude vegetable oil and separating the resulting mixture into a washed oil 429 and hydrated gums 427, for example using centrifugal separation. The hydrated gums 427 are, in this embodiment, mixed with the oil cake 430.

Bleaching step 455 also proceeds in the manner as above described, though with a chlorine free bleaching agent such as an acid activated bentonite, for example an acid activated calcium bentonite available from Clariant under the trade mark Tonsil Supreme 134FF. Bleached oil is directed to steam deodourisation step 460 which differs from the practice as described above in important respects.

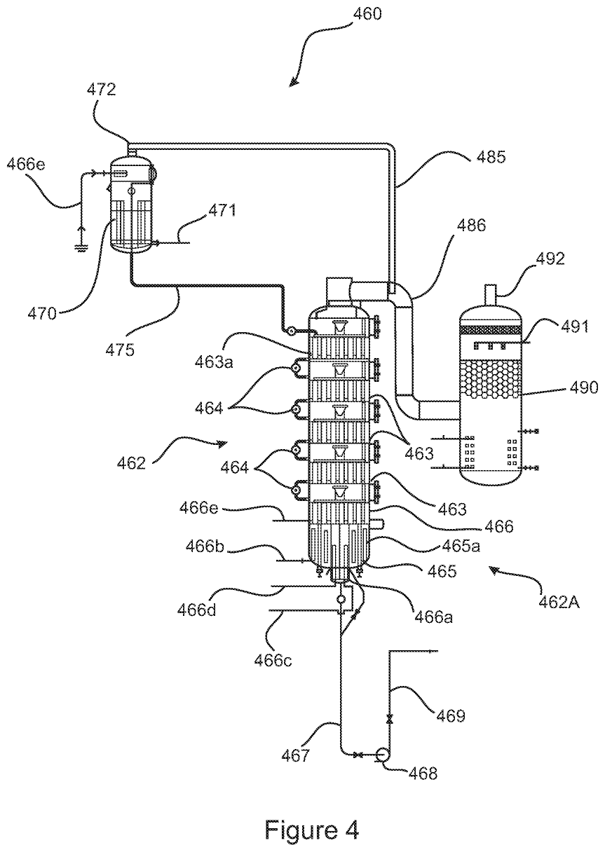

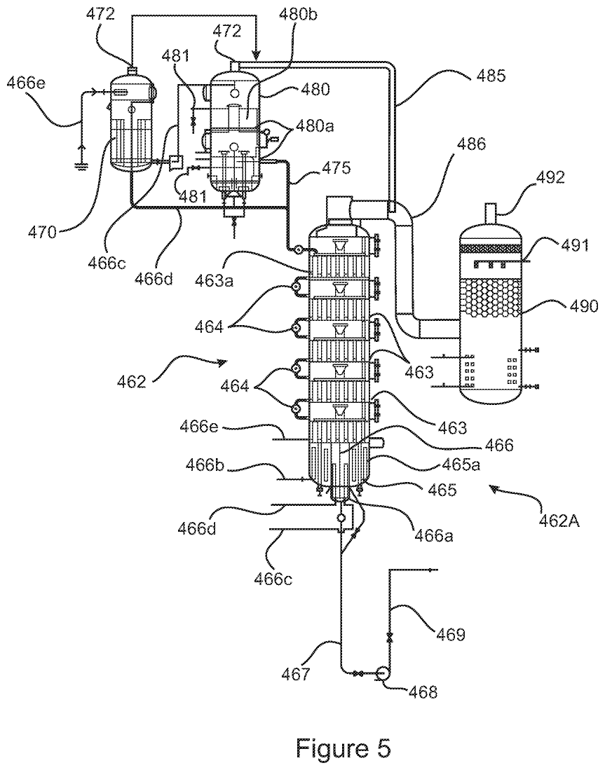

Steam deodourisation step 460 is conducted, as illustrated in FIGS. 4 and 5, in a tower 462, in this embodiment provided with four vertically spaced overflow trays 463, 463a. Tower 462, in contrast to a so-called ‘soft column’, includes no packing and is sized for a residence time between 30 and 120 minutes, in this embodiment 100 minutes, at a desired crude oil flowrate (here 3500 kgs/hr) through the tower 462. Overflow trays 463, 463a have headspace selected to facilitate free fatty acid volatilisation and disengagement from the oil. Preferably, headspace is in the range about 70-80% of tray height. Thus, where tray 463, 463a height is 1150 mm and oil height is 300 mm, headspace is 850 mm.

At each overflow tray 463, steam at required temperature and pressure or rate (1-1.5 barg) is directed through steam nozzles 464, as shown in FIGS. 4 and 5, to strip free fatty acids from the oil. Stripping steam rate is controlled, in this embodiment, dependent on the free fatty acid content of the crude canola oil and preferably according to Bailey's equation for deodourisation. Vacuum is maintained in the range 0.5 to 1.5 torr with steam stripping rate being about 20 kg/hr at 0.5 torr and about 40 kg/hr at 1.0 torr. Volatilised fatty acids are directed through duct 486 extending from the top of tower 462 to the vapour handling system, here scrubber 490 which operates as described below.

Steam 562 used in deodourisation step 460 and delivered to steam nozzles 464 is generated from water substantially free of chlorine. This is achieved by subjecting water 561 to be used in generating steam to a chlorine removal process, conveniently a membrane treatment process such as reverse osmosis stage 563, to remove chlorine in the form of free chlorine where present (whether from chlorination or chlorine containing contaminants in the water) or in the form of chloride salts. The absence of chlorine assists in avoiding the formation of 3-MCPD, at distillation temperatures, through the following mechanism:

acyl glycerols (mono-, di- or tri-)+Cl⁻+H⁺- - - →3-MCPD

because Cl⁻ is not present in the water. The H⁺ is provided by fatty acids present in the oil. Other organic chlorine may be present in the oil, the compounds having been formed through a mechanism mediated by Cl⁻ and H⁺.

It will be observed that both chlorine removal or reduction stages—washing stage 422 and reverse osmosis stage 563—are located upstream of deodourisation step 460.

The bottom 462A of tower 462 comprises an outer shell 465 and an inner shell 466, both of which contain indirect heaters in the form of a set of immersion coils 465a and 466a. Bleached oil 466c from bleaching step 455 is directed to inner shell 466 where it is heated, for example about 30° C., by deodourised oil 467 flowing through immersion coil 466a. The heated bleached oil 466d is then directed to deaerator (not shown). The deaerator removes air prior to re-direction of oil 466b back to the bottom of tower 462. The presence of air in the oil would interfere with downstream heating processes as described further below.

Outer shell 465 of bottom 462A of tower 462 has a set of immersion coils 465a which heats oil 466b from the deaerator to a temperature (T₁) significantly lower than the distillation temperature, in this case T₁=190° C., through heat exchange with oil 468 flowing from the bottom tray of the tower 462 (and through the immersion coils 465a). The heated oil 466e is then directed to thermic fluid heaters (not shown)—which operate for example by indirect heat exchange with a thermic fluid such as an oil—for heating to target distillation temperature (226 to about 230° C.) prior to delivery, through line 475 to top tray (tray 1) 463a of tower 462 for distillation treatment for removal of free fatty acids, while minimising trans-fat formation under the conditions described in this specification. Maintaining the target distillation temperature below about 230° C., more specifically 228-230° C., assists in avoiding significant GE formation in the oil.

Following oil refining in distillation tower 462, refined oil 467 is pumped from the bottom of distillation tower 462 by pump 468 through line 469 to cooling and storage.

It will be appreciated that there is a temperature profile over the trays 463 of tower 462, the lowest temperature being at the bottom tray and the highest at the top tray 463a with about a 5° C. difference between the two.

Prior to direction to tower 462, heated oil 463—at distillation target temperature below 230° C. as measured at the inlet to splasher 470 described below—is conveniently directed to a vacuum flasher or splasher 470 maintained under high vacuum (for example 0.5-1. Torr). Stripping steam may be supplied to splasher 470 through line 471 at 1-1.5 barg pressure. Line 466e delivers oil to splasher 470 at an expander arranged at an angle. This allows flashing off of 50-60% of free fatty acids with the object of reducing vapour load in upstream equipment, notably tower 462, and increasing oil throughput capacity. Flashed fatty acids are drawn by vacuum through port 472 and vapour line 485 and duct 486 to the scrubber 490 of the deodourisation stage. Temperature drop in the splasher 470 may, in some cases, be sufficient to drop oil temperature a few degrees, say 5° C., to a temperature below target distillation temperature. In such case, a thermic heater or immersion coil—for example operating as described above—may be included in either or both of the splasher 470 and pre-distiller 480 (as described below) to reheat the oil to the target distillation temperature.

Scrubber 490 is a packed tower configured to collect and condense fatty acid vapours volatilised in deodourisation step 460 and delivered to scrubber 490 by duct 486. The fatty acid and other volatile vapours are condensed by cooling with a recirculating stream of liquid fatty acid containing condensate through sprayer 491. A non condensed vapour stream flows through line 492 to an ejector system for further release to atmosphere during deodourisation as known in the art of vegetable oil refining.

The advantages of the scheme 400 and deodourisation system 460 as above described are emphasised by the following example for a canola oil processed as described above.

The above scheme 400 achieves the above refined oil composition without chemical refining and uses a single distillation tower 462 at low vacuum and steam stripping rate. In addition, the refined oil was tested for 3-MCPD content and GE content with both 3-MCPD and GE being undetectable. The target set for 3-MCPD was a

| | | | Free fatty | | | | |
|---|---|---|---|---|---|---|---|
| | Free Fatty | | Acid (FFA) | | | | |
| | Acid | | Content of | | | | |
| | Content of | Total | Refined | | AVG | Sparging | |
| | Crude | Trans | Canola | Average | process | Steam | Flow rate |
| | canola oil | Fat | oil | Vacuum | Temp | pressure | (Tonne |
| | (wt %) | (wt %) | (wt %) | (Torr) | (° C.) | (barg) | per day) |
| 1 | 0.28 | 0.64 | 0.068 | 1 | 229.5 | 1.4 | 84.0 |
| 2 | 0.28 | 0.59 | 0.070 | 1.2 | 228.2 | 1.4 | 83.4 |
| 3 | 0.28 | 0.57 | 0.066 | 1.5 | 228 | 1.4 | 80.0 |
| 4 | 0.30 | 0.80 | 0.049 | 1 | 229 | 1.4 | 84.0 |
| 5 | 0.32 | 0.64 | 0.068 | 1.2 | 230.8 | 1.4 | 84.0 |
| 6 | 0.30 | 0.61 | 0.063 | 1 | 228 | 1.4 | 84.0 |
| 7 | 0.30 | 0.57 | 0.069 | 1 | 228 | 1.4 | 84.0 |
| 8 | 0.30 | 0.61 | 0.063 | 1 | 228 | 1.4 | 84.0 |

maximum 1 ppm (1000 ppb) and for GE a maximum 0.5 ppm (500 ppb).

As to other contaminants, Mineral Oil Aromatic Hydrocarbon (MOAH) was not detected and Mineral Oil Saturated Hydrocarbon (MOSH) was 9.2 ppm against a target of 13 ppm maximum.

The above results show that it is not necessary to employ a second post bleaching and post deodourisation step or conduct further chemical refining operations following deodourisation to reduce 3-MCPD and GE levels below detectable limits. The oil is also well adapted to ‘numbers free’ applications and the applicable premium pricing.

Refined oil from deodourisation step is suitable for production of particular goods—including infant formulas or food for elderly people as known in the art or pharmaceutical ingredients—using such refined oils. Such goods made with a refined oil as exemplified above would also meet regulatory levels for 3-MCPD and GE.

In another embodiment, as shown in FIG. 5, deodourisation system 460, includes a pre-distiller 480 in addition to the flasher (splasher) 470. As with flasher 470, the pre-distiller 480 is included to reduce vapour load in the tower 462 (particularly for oils which, in crude state, contain high input free fatty acids (FFA), say >0.5 wt % FFA and is expected to significantly assist to increase oil throughput capacity, potentially from 85 tpd to 150 tpd oil throughput. Pre-distiller 480 operates on the same principle as distillation tower 462 and may also be considered a secondary distiller. Steam for stripping free fatty acids from the oil is supplied through steam line 481.

The pre-distiller 480—which is also provided with plural trays, in this case two vertically spaced trays 480a, the upper tray 480b of which is supplied with oil from line 466c from splasher 470 at target distillation temperature (225-about 230° C.). A steam pump may be used to drive oil from the splasher 470 into the upper tray 480b of pre-distiller 480. Line 466d is a drain line which would typically be used when plant stoppages for maintenance are required.

From the upper tray 480a of upper compartment 480b, oil overflows downward under influence of gravity to the lower tray 480a with free fatty acids being volatilised and stripped with steam during this process. Trays 480a are advantageously be configured with more head space 480b (for example 1150 mm for the upper tray 480a and 900 mm for the tray 480a below it) than available for the trays 463, 463a in distillation tower 462 which allows fatty acid vapours to be driven off, through vapour line 485 and vapour duct 486 to scrubber 490, more effectively even than in distillation tower 462. Oil is directed through line 462a to top tray 463a of distillation tower 462. Stripping steam is delivered to pre-distiller 480 through lines 481. Operating conditions for pre-distiller 480—which is also operated under vacuum—include 0.5-1.5 Torr absolute pressure, 225-230° C. temperature—and an exemplary stripping steam pressure of 1 barg, comparable with those for distillation tower 462.

Thus, the combination of distillation tower 462, splasher 470 and pre-distiller 480 in the deodourisation of vegetable oil—which forms a further aspect of the present invention—may be operated to increase the overall efficiency of the vegetable oil refining process as compared to using a distillation tower 462 alone.

Although step 460 has been described in this specification as a deodourisation step, it has the primary duty in process scheme 400 of free fatty acid removal while minimising trans fat formation, a duty that is shared in chemical refining processes with the chemical refining steps. Such processes may be more economic because lower distillation tower temperatures can be used. However, the product oil contains residues from the chemical refining steps and the Applicant has sought to develop a process which avoids such residues, lowers trans fat and free fatty acid levels and which may be attractive to a segment of the vegetable oil market.

Modifications and variations to the process of refining a vegetable oil as described in this specification may be apparent to those skilled in the art. Such modifications and variations are deemed within the scope of the present invention.

Throughout this specification, unless the context requires otherwise, the word “comprise” or variations such as “comprises” or “comprising”, will be understood to imply the inclusion of a stated integer or group of integers but not the exclusion of any other integer or group of integers.

The invention described herein may include one or more range of values (e.g. temperature, pressure, volume, weight and time). A range of values will be understood to include all values within the range, including the values defining the range, and values adjacent to the range which lead to the same or substantially the same outcome as the values immediately adjacent to that value which defines the boundary to the range.

1. A process for physically refining a vegetable oil comprising a step of deodourising a crude vegetable oil by steam distillation under refining conditions effective to produce a refined vegetable oil having a trans-fat content of less than 0.99 wt %, said steam being generated from water substantially free of chlorine.

2. The process of claim 1, wherein said steam distillation is conducted with pressurised stripping steam under vacuum and is conducted under a plurality of controlled conditions selected from the group consisting of vacuum pressure, temperature, stripping steam rate, stripping stream pressure, fatty acid vapour pressure, crude oil flowrate through steam distillation and combinations thereof.

3. The process of claim 2, wherein steam distillation is conducted at a steam stripping rate to minimise hydrolysis of the vegetable oil and formation of glycidyl esters (GEs).

4. The process of claim 3, wherein steam is generated from water or condensate treated to minimise or remove chlorine.

5. The process of claim 4, wherein chlorine introduced to water by a chlorination process or as chlorides is removed by a membrane treatment, optionally reverse osmosis, to remove chlorine or chlorides.

6. The process of claim 1 comprising washing of oil or oil seeds with chlorine free water to remove chlorine.

7. The process of claim 4, wherein steam distillation temperature is less than 230° C. and steam distillation is conducted at a vacuum less than 1.5 torr.

8. The process of claim 7, wherein steam distillation temperature is in the range 220-230° C.

9. The process of claim 8, wherein steam distillation temperature is in the range 225-230° C.

10. The process of claim 9, wherein vacuum is in the range 0.5 to 1.0 torr.

11. The process of claim 10, wherein stripping stream pressure is controlled in the range of 0.8 bar gauge to 2.0 bar gauge and residence time in the distillation vessel is within the range 30 minutes to 120 minutes.

12. (canceled)

13. The process of claim 11, wherein organic chlorine content and glycidyl ester (GE) content in the refined oil is reduced to below 1.0 ppm.

14. The process of claim 13, wherein organic chlorine content and GE content in the refined oil is reduced to below 0.5 ppm.

15. The process of claim 14, wherein content of MOSH and MOAH compounds in the refined oil is reduced to undetectable levels.

16. The process of claim 15, wherein free fatty acid (FFA) contents in the refined oil are reduced to less than 0.1 wt %.

17. The process of claim 16, wherein trans fat content in the refined oil is less than 0.8 wt %, more preferably less than 0.7 wt % and most preferably less than 0.6 wt %.

18. An apparatus for physically refining a vegetable oil comprising a deodourising vessel for steam distillation of a crude vegetable oil with steam under refining conditions effective to produce a refined vegetable oil having a trans-fat content of less than 0.99 wt %, said steam being generated from water substantially free of chlorine.

19. The apparatus of claim 18, wherein said vessel is a distillation tower having a plurality of vertically spaced trays with conditions at each tray being controlled to achieve said effective conditions.

20. The apparatus of claim 19, comprising, upstream of the distillation tower at least one further free fatty acid volatilisation process vessels, selected from the group consisting of flashing and pre-distillation vessels.

21. A process for physically refining a vegetable oil comprising the steps of:
(a) extracting a crude vegetable oil;
(b) degumming and bleaching the crude vegetable oil for initial removal of impurities; and
(c) deodourising a crude vegetable oil by steam distillation under conditions effective to produce a refined vegetable oil having a trans fat content of less than 0.99 wt %; and further comprising a chlorine reduction step.

22. The process of claim 21, wherein said chlorine reduction step is conducted upstream of the deodourisation step.

23. The process of claim 22, wherein a plurality of chlorine reduction steps are included.

24. An apparatus for physically refining a vegetable oil comprising:
(a) a presser, operated at ambient conditions, for extracting a crude vegetable oil;
(b) a series of vessels for degumming and bleaching the crude oil for initial removal of impurities;
(c) a vessel for deodourising a crude vegetable oil by steam refining under conditions effective to produce a refined vegetable oil having a trans-fat content of less than 0.99 wt %; and
(d) a chlorine removal stage.

25. The apparatus of claim 24, wherein said chlorine removal stage is provided upstream of the deodourising vessel.

26. (canceled)
